(19) United States
(12) Patent Application Publication
(10) Pub. No.: US 2020/0125409 A1
(43) Pub. Date: Apr. 23, 2020

(54) IMPLEMENTING EFFICIENT UTILIZATION AFTER DYNAMIC RESOURCE OPTIMIZATION THRESHOLD IS EXCEEDED

(71) Applicant: International Business Machines Corporation, Armonk, NY (US)

(72) Inventors: Michael J. Belliveau, Travis, TX (US); Zahed Hossain, Bangalore (IN); Sandhya S. Kudpi, Bangalore (IN); Brian M. Carpenter, Austin, TX (US)

(21) Appl. No.: 16/167,821

(22) Filed: Oct. 23, 2018

(51) Int. Cl. G06F 9/50; G06F 9/48

(52) U.S. Cl. CPC G06F 9/505; G06F 9/5038; G06F 2209/504; G06F 2209/5022; G06F 9/4881

(57) ABSTRACT

A method and system are provided for implementing enhanced resource utilization in Power Virtualization Center (Power VC) after a dynamic resource optimization (DRO) threshold is exceeded on all processors. A new DRO threshold by the system processor with a least utilization is defined. Utilizing the resources from the least utilized system processor to a highly utilized processor is enabled by the new DRO threshold.

### FIELD OF THE INVENTION

The present invention relates generally to the data processing field, and more particularly, relates to method and system for implementing efficiently utilizing resources in Power Virtualization Center, such as IBM® PowerVC™ on identifying that the dynamic resource optimization (DRO) threshold is exceeded on all processors.

### DESCRIPTION OF THE RELATED ART

IBM® PowerVC™ is an advanced virtualization and cloud management offering. Built on OpenStack, it provides simplified virtualization management and cloud deployments for IBM AIX®, IBM i and Linux virtual machines (VMs) running on IBM Power Systems™. The offer is designed to build private cloud on the Power Systems servers and improve administrator productivity. It can further integrate with multi-cloud environments through higher-level cloud orchestrators.

Currently, when the Dynamic Resource Optimization (DRO) threshold is hit, that system will no longer give up processor resources for optimization. As a result with multiple systems and all systems are above the set threshold, the systems will not give up resources to balance the load. That is with a set DRO threshold of 50%, and one system is running at 51% (System A) and the other at 100% (System B), System A will not give up any processor resource to help optimize System B.

A need exists for an efficient and effective method and system for implementing enhance utilization of resources in a Power Virtualization Center on identifying that a respective dynamic resource optimization (DRO) threshold is exceeded on all processors.

### SUMMARY OF THE INVENTION

Principal aspects of the present invention are to provide a method and system for implementing enhanced resource utilization after a Power Virtualization Center (Power VC) dynamic resource optimization (DRO) threshold is exceeded on all processors. Other important aspects of the present invention are to provide such method and system substantially without negative effects and that overcome many of the disadvantages of prior art arrangements.

In brief, a method and system are provided for implementing enhanced resource utilization in Power Virtualization Center (Power VC) after a dynamic resource optimization (DRO) threshold is exceeded on all processors. A new DRO threshold by the system processor with a least utilization is defined. Utilizing the resources from the least utilized system processor to a highly utilized processor is enabled by the new DRO threshold.

In accordance with features of the invention, balancing all processors utilization by utilizing the resources from the system with least utilized system processor to a higher utilized processor enables improved overall performance in the Power Virtualization Center management.

In accordance with features of the invention, the new DRO threshold by the system processor with a least utilization is defined by overriding of processors to disable DRO due to thresholds and controlling the processors while overriding to define the new DRO threshold.

In accordance with features of the invention, utilizing the resources from the least utilized processor to a highly utilized processor enables balancing all processors utilization.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram of an example computer system for implementing enhanced resource utilization after a dynamic resource optimization (DRO) threshold is exceeded on all processors in Power Virtualization Center (Power VC) in accordance with the preferred embodiment;

FIG. 2 is a flow chart illustrating example operations for implementing enhanced resource utilization in Power Virtualization Center (Power VC) after a dynamic resource optimization (DRO) threshold is exceeded on all processors in accordance with the preferred embodiment; and

FIG. 3 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention. In particular, references to “file” should be broadly considered to include and may be substituted with block, page or any other logical subdivision of data,

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and apparatus are provided for implementing enhanced resource utilization in Power Virtualization Center (Power VC) after a dynamic resource optimization (DRO) threshold is exceeded on all processors.

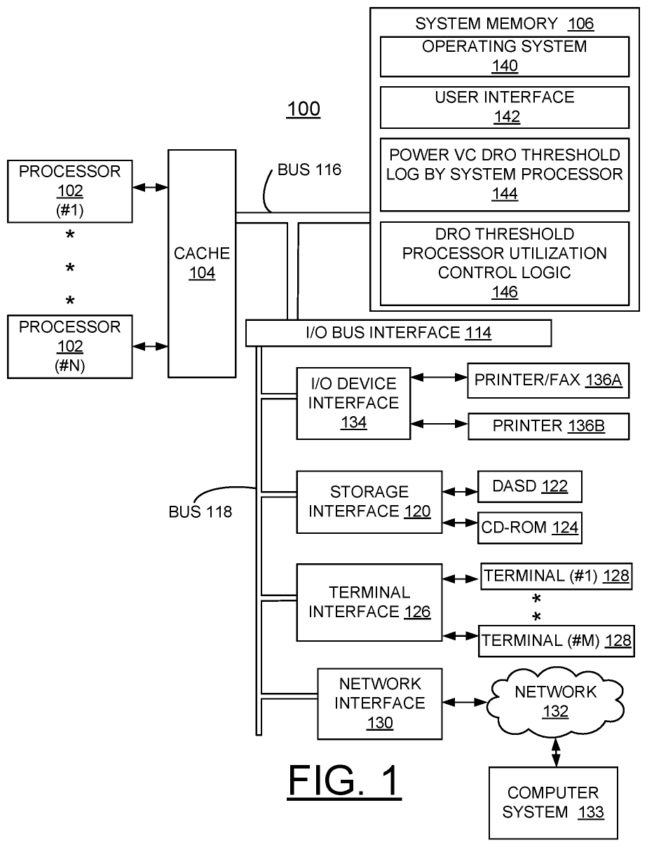

Having reference now to the drawings, in FIGS. 1, there is shown a computer system embodying the present invention generally designated by the reference character 100 for implementing enhanced resource utilization in Power Virtualization Center (Power VC) after a dynamic resource optimization (DRO) threshold is exceeded on all processors in accordance with the preferred embodiment. Computer system 100 includes one or more processors 102 or general-purpose programmable central processing units (CPUs) 102, #1-N. As shown, computer system 100 includes multiple processors 102 typical of a relatively large system; however, system 100 can include a single CPU 102. Computer system 100 includes a cache memory 104 connected to each processor 102.

Computer system 100 includes a system memory 106. System memory 106 is a random-access semiconductor memory for storing data, including applications and programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

I/O bus interface 114, and buses 116, 118 provide communication paths among the various system components. Bus 116 is a processor/memory bus, often referred to as front-side bus, providing a data communication path for transferring data among CPUs 102 and caches 104, system memory 106 and I/O bus interface unit 114. I/O bus interface 114 is further coupled to system I/O bus 118 for transferring data to and from various I/O units.

As shown, computer system 100 includes a storage interface 120 coupled to storage devices, such as, a direct access storage device (DASD) 122, and a CD-ROM 124. Computer system 100 includes a terminal interface 126 coupled to a plurality of terminals 128, #1-M, a network interface 130 coupled to a network 132, such as the Internet, local area or other networks, shown connected to another separate computer system 133, and a I/O device interface 134 coupled to I/O devices, such as a first printer/fax 136A, and a second printer 136B.

I/O bus interface 114 communicates with multiple I/O interface units 120, 126, 130, 134, which are also known as I/O processors (IOPs) or I/O adapters (IOAs), through system I/O bus 116. System I/O bus 116 is, for example, an industry standard PCI bus, or other appropriate bus technology.

System memory 106 stores an operating system 140, a user interface 142, a DRO threshold log by system processor 144, and a DRO threshold processor utilization control logic 146 in accordance with the preferred embodiments.

In accordance with features of the invention, resources in power virtualization center (PowerVC) are efficiently utilized on identifying that the dynamic resource optimization (DRO) threshold is exceeded on all processors. The DRO threshold processor utilization control logic 146 enables detecting and overriding of processors to disable DRO due to thresholds and controlling the processors while overriding by defining a new dynamic DRO threshold by the system/processor with the least utilization. Balancing all processors utilization is enabled by utilizing the resources from the least utilized processor to the highly utilized processor.

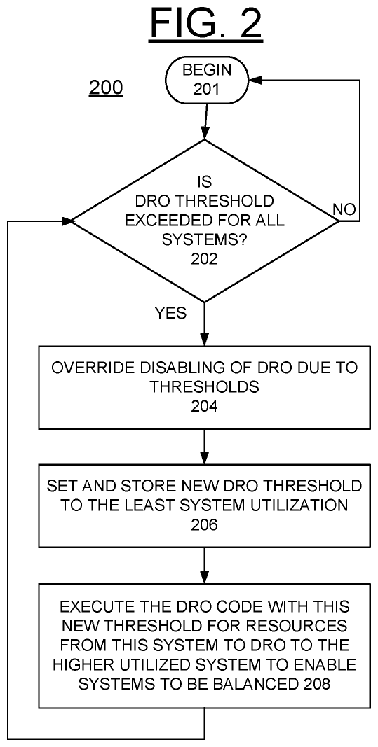

Referring now to FIG. 2, there is shown an example flow chart illustrating example operations generally designated by the reference character 200 for implementing enhanced resource utilization in Power Virtualization Center (Power VC) after a dynamic resource optimization (DRO) threshold is exceeded on all processors in accordance with the preferred embodiment, with operations beginning at a block 201.

Checking whether the DRO threshold is exceeded for all systems, as indicated at a decision block 202. In this manner, the a DRO threshold processor utilization control logic 146 of the present invention uses the Power Virtualization Center (Power VC) DRO threshold log by system processor 144 detecting when the DRO threshold is exceeded for all systems.

In the Power Virtualization Center (Power VC), the best performance can be obtained when the system is at the least utilization. And as system utilization increases, there is a bigger impact improvement to reduce that utilization. That is the reason for setting a DRO threshold; when a system has a lower utilization, there is not much advantage to reduce its' utilization. The shortcoming here is that once all the systems are above the threshold as identified at decision block 202, there is no more resource movement. Systems performance typically becomes unbalanced, and therefore reducing the overall performance.

When the DRO threshold is exceeded for all systems, override is provided for disabling of DRO due to thresholds as indicated at a block 204. As indicated at a block 206, a new dynamic DRO threshold is set or defined by the system with the least utilization and stored in the DRO threshold log by system processor 144. Resources from this system can then be made available to the higher utilized system in order to balance all the systems utilization. As indicated at a block 208, a DRO code is executed with the new DRO threshold for resources from this system with least system utilization to the higher utilized system to enable systems to be balanced. Operations return to decision block 202 to continue detecting when the DRO threshold is exceeded for all systems.

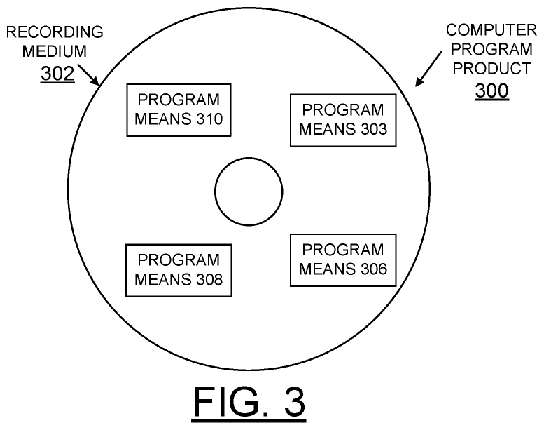

Referring now to FIG. 3, an article of manufacture or a computer program product 300 of the invention is illustrated. The computer program product 300 is tangibly embodied on a non-transitory computer readable storage medium that includes a recording medium 302, such as, a floppy disk, a high capacity read only memory in the form of an optically read compact disk or CD-ROM, a tape, or another similar computer program product. The computer readable storage medium 302, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 302 stores program means or instructions 304, 306, 308, and 310 on the non-transitory computer readable storage medium 302 for carrying out the methods for implementing enhanced resource utilization in Power Virtualization Center (Power VC) after a dynamic resource optimization (DRO) threshold is exceeded on all processors in the system 100 of FIG. 1.

Computer readable program instructions 304, 306, 308, and 310 described herein can be downloaded to respective computing/processing devices from a computer readable storage medium or to an external computer or external storage device via a network, for example, the Internet, a local area network, a wide area network and/or a wireless network. The computer program product 300 may include cloud based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 304, 306, 308, and 310 from the network and forwards the computer readable program instructions for storage in a computer readable storage medium within the respective computing/processing device.

A sequence of program instructions or a logical assembly of one or more interrelated modules defined by the recorded program means 304, 306, 308, and 310, direct the system 100 for implementing enhanced resource utilization in Power Virtualization Center (Power VC) after a dynamic resource optimization (DRO) threshold is exceeded on all processors of the preferred embodiment.

While the present invention has been described with reference to the details of the embodiments of the invention shown in the drawing, these details are not intended to limit the scope of the invention as claimed in the appended claims.

What is claimed is:

1. A computer-implemented method for implementing enhanced resource utilization in a Virtualization Center (VC) after a dynamic resource optimization (DRO) threshold is exceeded on all processors, said computer-implemented method implemented in a computer system including a processor, a DRO threshold processor utilization control logic tangibly embodied in a non-transitory machine readable medium, said a DRO threshold processor utilization control logic comprising:
responsive to identifying the DRO threshold being exceeded on all processors, defining a new DRO threshold by the system processor with a least utilization; and
enabling utilization of resources from the least utilized system processor to a highly utilized processor with the new DRO threshold.

2. The method as recited in claim 1, wherein responsive to identifying the DRO threshold being exceeded on all processors, defining a new DRO threshold by the system processor with a least utilization includes overriding disabling of dynamic resource optimization (DRO) due to DRO threshold, and storing the new DRO threshold.

3. The method as recited in claim 2, includes providing a DRO threshold log, and wherein storing the new DRO threshold includes storing the new DRO threshold in the DRO threshold log.

4. The method as recited in claim 2, wherein overriding disabling of dynamic resource optimization (DRO) due to DRO threshold includes enabling execution of DRO code with the defined new DRO threshold.

5. The method as recited in claim 1, wherein enabling utilization of resources from the least utilized system processor to a highly utilized processor with the new DRO threshold includes executing DRO code with the defined new DRO threshold.

6. The method as recited in claim 5, wherein executing DRO code with the defined new DRO threshold enables systems to be balanced after dynamic resource optimization (DRO) threshold is exceeded on all processors.

7. A system for enhanced resource utilization in a Virtualization Center (VC) after a dynamic resource optimization (DRO) threshold is exceeded on all processors, comprising:
a processor;
a DRO threshold processor utilization control logic tangibly embodied in a non-transitory machine readable medium;
said processor using said DRO threshold processor utilization control logic to perform:
responsive to identifying the DRO threshold being exceeded on all processors, defining a new DRO threshold by the system processor with a least utilization; and
enabling utilization of resources from the least utilized system processor to a highly utilized processor with the new DRO threshold.

8. The system as recited in claim 7, wherein responsive to identifying the DRO threshold being exceeded on all processors, defining a new DRO threshold by the system processor with a least utilization includes overriding disabling of dynamic resource optimization (DRO) due to DRO threshold, and storing the new DRO threshold.

9. The system as recited in claim 8, includes providing a DRO threshold log, and wherein storing the new DRO threshold includes storing the new DRO threshold in the DRO threshold log.

10. The system as recited in claim 8, wherein overriding disabling of dynamic resource optimization (DRO) due to DRO threshold includes enabling execution of DRO code with the defined new DRO threshold.

11. The system as recited in claim 7, wherein enabling utilization of resources from the least utilized system processor to a highly utilized processor with the new DRO threshold includes executing DRO code with the defined new DRO threshold.

12. The system as recited in claim 11, wherein executing DRO code with the defined new DRO threshold enables systems to be balanced after dynamic resource optimization (DRO) threshold is exceeded on all processors.
